(19) United States
(12) Patent Application Publication
(10) Pub. No.: US 2025/0281864 A1
(43) Pub. Date: Sep. 11, 2025

(54) AIR CLEANER

(71) Applicant: LG ELECTRONICS INC., Seoul (KR)

(72) Inventors: Sejin CHOI, Seoul (KR); Hojung KIM, Seoul (KR); Changkyum KIM, Seoul (KR); Chiyoung CHOI, Seoul (KR)

(73) Assignee: LG ELECTRONICS INC., Seoul (KR)

(21) Appl. No.: 19/073,767

(22) Filed: Mar. 7, 2025

(30) Foreign Application Priority Data
Mar. 8, 2024 (KR) 10-2024-0033179

(51) Int. Cl. B01D 46/00; B01D 46/24

(52) U.S. Cl. CPC B01D 46/0049; B01D 46/0002; B01D 46/2403; B01D 2273/30

(57) ABSTRACT

Disclosed is an air cleaner. The air cleaner includes a case including a suction port disposed in a peripheral surface of the case, the suction port being configured to introduce air to an inside of the case, a filter configured to remove foreign matter from the air introduced through the suction port, a blower fan disposed in the case that is configured to blow the air introduced through the suction port after the air is filtered by the filter, a discharge port disposed below the blower fan and the filter, the discharge port being configured to discharge the air blown by the blower fan in a downward direction, and a bottom plate disposed below the blower fan and the filter that is configured to be in contact with a floor, the bottom plate including a boss protruding upward.

### CROSS-REFERENCE TO RELATED APPLICATION

This application claims the priority benefit of Korean Patent Application No. 10-2024-0033179, filed on Mar. 8, 2024 in the Korean Intellectual Property Office, the disclosure of which is incorporated herein by reference.

### BACKGROUND OF THE INVENTION

### 1. Field of the Invention

The present disclosure relates to an air cleaner, and more particularly to an air cleaner capable of exhibiting improved air cleaning performance.

### 2. Description of the Related Art

An air cleaner is a device that filters air in a certain space and discharges the filtered air, thereby reducing the concentration of dust or bacteria in the air in the corresponding space. The air cleaner filters out foreign matter by generating a flow of air in the corresponding space, and discharges air with the foreign matter removed therefrom.

In order to quickly purify air in the indoor space, a discharge port may be formed in an upper portion of an air cleaner, and filtered air discharged upwardly may be guided so as to flow in all directions.

Further, in the case in which a discharge port is formed in an upper portion of an air cleaner, a separate fan for regulation of the direction of air discharged may be disposed at an upper portion of the air cleaner in order to cause filtered air to flow a long distance.

Related Art Document 1 (Korean Patent Laid-Open Publication No. 10-2020-0112592) discloses an air cleaner including a discharge port formed in the upper end thereof.

Related Art Document 2 (Korean Patent Laid-Open Publication No. 10-2017-0140578) discloses an air cleaner including blowing devices disposed in an upward-downward direction and discharge ports formed in the upper portion and the central portion thereof.

However, because the air cleaners of the related art discharge purified air upwardly, the discharge airflow directly reaches a user, thus causing discomfort to the user. Further, the air cleaners of the related art having this discharge structure have a limitation in removing particles that are relatively large and heavy and thus tend to settle on the floor.

### SUMMARY OF THE INVENTION

An aspect of the present disclosure is directed to providing an air cleaner capable of preventing a discharge airflow from directly reaching a user and thus causing discomfort to the user.

Another aspect of the present disclosure is directed to providing an air cleaner capable of forming an airflow that effectively removes large and heavy particles.

A further aspect of the present disclosure is directed to providing an air cleaner capable of forming an airflow that effectively removes allergens causing allergies.

Still another aspect of the present disclosure is directed to providing an air cleaner capable of achieving improved air cleaning performance on large particles as well as small particles.

An air cleaner according to an embodiment of the present disclosure is configured to discharge purified air through the bottom thereof, thereby preventing the discharge airflow from directly reaching a user and thus causing discomfort to the user.

An air cleaner according to an embodiment of the present disclosure is configured to form an airflow at a height at which allergens causing allergies are mainly located, thereby effectively removing the allergens.

An air cleaner according to an embodiment of the present disclosure includes a case having a suction port formed in the peripheral surface thereof, a blower fan disposed in the case, a filter configured to remove foreign matter from air introduced through the suction port, and a discharge port formed below the blower fan and the filter. Air with the foreign matter removed therefrom is discharged downwardly through the discharge port, thereby preventing the discharge airflow from directly reaching a user and thus causing discomfort to the user and effectively removing allergens.

The air cleaner according to the embodiment of the present disclosure further includes a bottom plate disposed below the blower fan and the filter so as to be in contact with the floor, and the bottom plate includes a boss protruding upward.

A curved portion, a flat portion extending laterally from the curved portion, and a boss protruding upward from an end portion of the flat portion may be formed on an upper surface of the bottom plate.

The boss may include an inclined surface, the height of which gradually increases in a radially outward direction.

The maximum height of the boss may be less than 10% of the radius of curvature of the curved portion.

The boss may be formed in a ring shape along the edge of the bottom plate.

The bottom plate may further include a central pillar supporting the blower fan from below, and the curved portion may be formed so as to surround the central pillar.

An angle between the central pillar and the curved portion may be smaller than the angle of the discharge airflow through the discharge port.

A lower discharge grille including a plurality of grilles may be disposed inside the discharge port in order to guide air discharged downwardly in the radially outward direction.

The plurality of grilles may have a concentric circle structure.

The plurality of grilles may have lengths greater than an interval between the plurality of grilles.

The plurality of grilles may be bent at a predetermined angle in the outward direction.

The predetermined angle may be 20 degrees to 40 degrees.

Each of the plurality of grilles may include a curved portion bent in the radially outward direction and a protruding portion protruding from an end portion of the curved portion in the radially outward direction.

The protruding portion may have a smaller thickness than the curved portion.

The length by which the protruding portion protrudes in the radially outward direction may be greater than the thickness of the curved portion.

An airflow guide may be disposed on an upper surface of the bottom plate so as to guide air discharged downwardly through the discharge port in the lateral direction.

The airflow guide may include a curved portion, a flat portion extending laterally from the curved portion, and a boss protruding upward from an end portion of the flat portion.

The boss may be formed in a ring shape along the edge of the airflow guide.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 is a view showing the external appearance of an air cleaner according to an embodiment of the present disclosure;

FIG. 2 is a cross-sectional view of the air cleaner according to the embodiment of the present disclosure;

FIGS. 3 and 4 are exploded views of the air cleaner according to the embodiment of the present disclosure;

FIGS. 5 to 7 are views for explaining discharge of purified air through the bottom of the air cleaner according to the embodiment of the present disclosure;

FIGS. 8 and 9 are views for explaining a lower discharge grille according to the embodiment of the present disclosure;

FIGS. 10A to 10C are views for explaining the shape of the grille according to the embodiment of the present disclosure;

FIGS. 11 and 12 are views for explaining allergen particles; and

FIG. 13 is a view for explaining performance comparison between an air cleaner that discharges purified air through the bottom thereof and an air cleaner that discharges purified air through the top thereof.

### DETAILED DESCRIPTION

Hereinafter, embodiments of the present disclosure will be described in detail with reference to the accompanying drawings. The present disclosure may, however, be embodied in many different forms, and should not be construed as being limited to the embodiments set forth herein.

In the drawings, illustration of parts unrelated to the description is omitted to clearly and briefly describe the present disclosure, and the same or extremely similar components are denoted by the same reference numerals throughout the specification.

As used herein, the terms with which the names of components are suffixed, “module” and “unit”, are assigned to facilitate preparation of this specification, and are not intended to suggest unique meanings or functions. Accordingly, the terms “module” and “unit” may be used interchangeably.

It will be understood that although the terms “first”, “second”, etc., may be used herein to describe various components, these components should not be limited by these terms. These terms are only used to distinguish one component from another component.

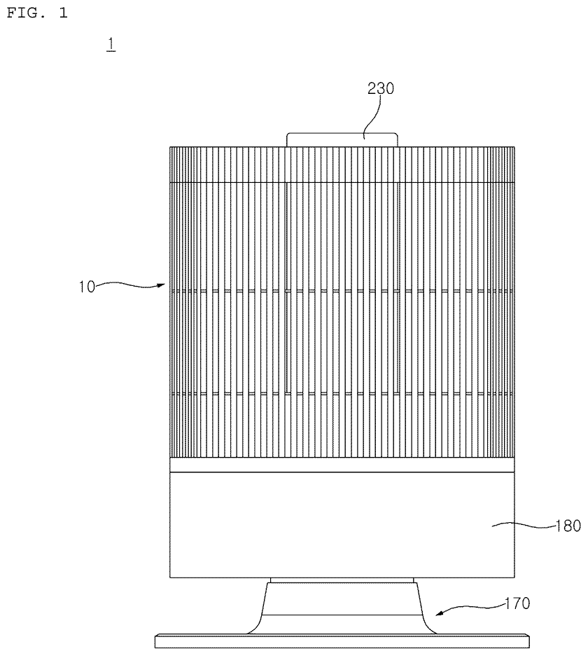

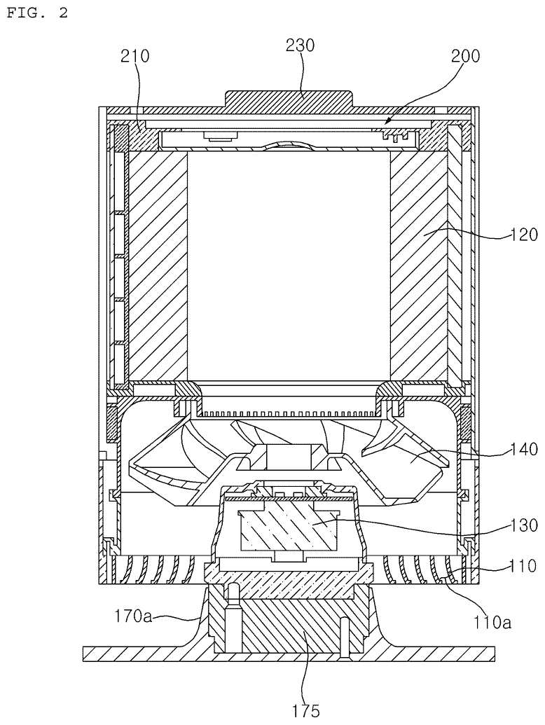

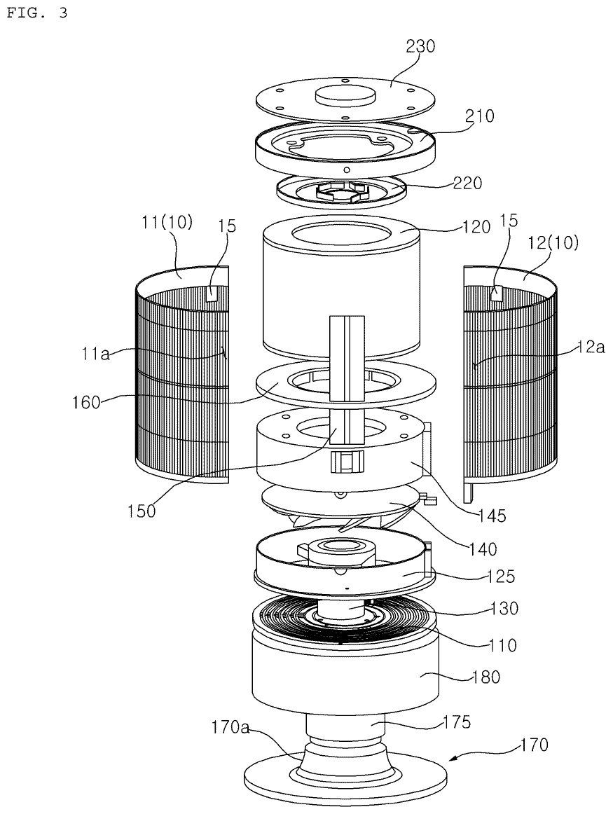

FIG. 1 is a view showing the external appearance of an air cleaner according to an embodiment of the present disclosure, and FIG. 2 is a cross-sectional view of the air cleaner according to the embodiment of the present disclosure. FIGS. 3 and 4 are exploded views of the air cleaner according to the embodiment of the present disclosure.

Referring to FIGS. 1 to 4, the air cleaner 1 includes a case 10 forming the external appearance thereof. The case 10 may have suction ports 11a and 12a formed in the peripheral surface thereof in order to suction air from various directions. Air may be suctioned from all directions with respect to a central line passing through the internal center of the case 10 in an upward-downward direction. The suction ports 11a and 12a are provided in plural, and the plurality of suction ports 11a and 12a is spaced apart from each other in the circumferential direction of the case 10. The plurality of suction ports 11a and 12a is evenly formed in the circumferential direction along the peripheral surface of the case 10 so that air is capable of being suctioned into the case 10 from any direction.

In this specification, the upward-downward direction or the vertical direction is defined as an axial direction. The axial direction may correspond to the central axis-direction of a blower fan 140, which will be described later, i.e., the motor shaft direction of the fan. The radial direction or the horizontal direction may be understood as a direction perpendicular to the axial direction. The circumferential direction may be understood as a circumferential direction of an imaginary circle that is formed when rotating about the axial direction with a distance in the radial direction as a rotational radius.

The air cleaner 1 includes a blower fan 140 disposed in the case 10 and a filter 120 configured to remove foreign matter from air introduced through the suction ports 11a and 12a.

The air introduced through the suction ports 11a and 12a may pass through the filter 120. The filter 120 may be formed in a cylindrical shape and may have a filter surface that filters air.

The case 10 may have a cylindrical shape. The case 10 may include a first case 11, which has a semi-cylindrical shape and covers a portion of the outer circumferential surface of the air cleaner 1, and a second case 12, which has a semi-cylindrical shape and covers the remaining portion of the outer circumferential surface of the air cleaner 1.

Alternatively, the case 10 may have a shape of a truncated cone (a cone with the top cut off), and each of the first case 11 and the second case 12 may have a shape of a semi-truncated cone.

The first case 11 and the second case 12 may be coupled to each other to form the external appearance of the air cleaner 1. Because the first case 11 covers the front surface of the air cleaner 1, the first case 11 may be referred to as a “front case” or a “front cover”. Because the second case 12 covers the rear surface of the air cleaner 1, the second case 12 may be referred to as a “rear case” or a “rear cover”.

The suction ports 11a and 12a include a first suction port 11a formed in the first case 11 and a second suction port 12a formed in the second case 12. The suction ports 11a and 12a allow the inside of the case 10 and the outside to communicate with each other. The suction ports 11a and 12a are provided in plural. The plurality of suction ports 11a and 12a may be formed in the peripheral surface of the case 10.

The plurality of suction ports 11a and 12a is evenly formed in the circumferential direction along the outer circumferential surface of the case 10 so that air is capable of being suctioned into the case 10 from any direction.

The plurality of suction ports 11a and 12a is formed in a stripe shape that is elongated in the upward-downward direction. Alternatively, the plurality of suction ports 11a and 12a may be formed through perforation in a circular or elliptical shape.

As described above, because the case 10 is formed in a cylindrical shape and the plurality of suction ports 11a and 12a is formed along the outer circumferential surface of the case 10, the amount of air suctioned may increase.

A discharge port 110a that is open downward is formed in a lower portion of the air cleaner 1. A lower discharge grille 110 is disposed inside the discharge port 110a in order to change the direction of air flowing upward.

The annular discharge port 110a is formed in a lower portion of the air cleaner 1. Air with foreign matter removed therefrom by the filter 120 is discharged downwardly through the discharge port 110a.

The lower discharge grille 110 may include a plurality of grilles bent at a predetermined angle in the outward direction. The lower discharge grille 110 may be disposed inside the discharge port 110a in order to deliver the lower discharge airflow in the lateral direction.

The air cleaner 1 includes a filter mounting part 160 to which the filter 120 is mounted. The filter 120 may be removably mounted to the filter mounting part 160. The filter 120 may have a hollow cylindrical shape, and air may be introduced through the outer circumferential surface of the filter 120. While the air passes through the filter 120, impurities such as fine dust may be removed from the air.

Because the filter 120 has a cylindrical shape, air is capable of being introduced into the filter 120 from any direction. Therefore, the air filtering area may increase.

The filter mounting part 160 may be formed in a cylindrical shape corresponding to the shape of the filter 120. In the process of mounting the filter 120, the filter 120 may be slidably fitted into the filter mounting part 160. Conversely, in the process of demounting the filter 120, the filter 120 may be slidably withdrawn from the filter mounting part 160.

The air cleaner 1 includes a discharge port 110a formed in the bottom thereof. The discharge port 110a is formed below the blower fan 140 and the filter 120. Air with foreign matter removed therefrom by the filter 120 is discharged downwardly through the discharge port 110a.

In addition, a lower discharge grille 110 including a plurality of grilles is disposed at the bottom of the air cleaner 1 in order to guide a lower airflow.

The lower discharge grille 110 may include a plurality of grilles having a concentric circle structure. The plurality of grilles may be a plurality of circles having the same center and different radii. Each of the plurality of grilles may include a section bent in the radially outward direction. The lower discharge grille 110 may include a plurality of grilles bent at a predetermined angle in the outward direction. The lower discharge grille 110 may be disposed inside the discharge port 110a in order to deliver the lower discharge airflow in the lateral direction.

A bottom plate 170 is disposed at a lower portion of the air cleaner 1. The bottom plate 170 is disposed in contact with the floor to support the air cleaner 1.

An airflow guide 170a is disposed on the upper surface of the bottom plate 170 in order to guide air discharged downwardly through the discharge port 110a in the lateral direction. The bottom plate 170 may further include a base 170b that supports the airflow guide 170a. The airflow guide 170a may be formed on the upper surface of the base 170b. In addition, the airflow guide 170a and the base 170b may be coupled to each other to constitute the bottom plate 170.

In addition, the bottom plate 170 may further include a central pillar 175 that supports the blower fan 140 from below.

Air with foreign matter removed therefrom by the filter 120 is discharged downwardly through the discharge port 110a.

General allergen particles have a size of about 3 μm to about 100 μm, which is greater than the size of fine dust, and thus tend to settle on the floor. The lower airflow discharged downwardly from the air cleaner 1 causes allergen particles to float in the air and thus to be collected by the filter 120. In this way, it is possible to effectively remove allergens causing allergies using the lower airflow discharged downwardly from the air cleaner 1.

In addition, the air cleaner 1 may include a UVC LED, which is disposed in the case 10 and outputs ultraviolet in a wavelength band that has a sterilization effect on bacteria, mold, and microorganisms, and an ionizer, which is disposed in the case 10 and eliminates germs and mold using electricity supplied thereto.

In addition, the air cleaner 1 includes a fan housing 145 accommodating the blower fan 140 and a support part 150 extending in the vertical direction from the fan housing 145. The support part 150 may extend in the longitudinal direction of the air cleaner 1.

The support part 150 may be provided in plural. For example, two support parts 150 may be disposed so as to face two opposite sides of the filter 120. The number of support parts 150 may be varied depending on the size or specifications of the product. Some of the support parts 150 may be different in at least one of shape, size, or material from the remaining ones of the support parts 150.

A bottom cover 180 is disposed at the bottom of the case 10. The lower discharge grille 110 is disposed inside the bottom cover 180.

The air cleaner 1 includes a fan housing 145 disposed below the filter 120, a blower fan 140 rotatably disposed in the fan housing 145, and a fan motor 130 configured to rotate the blower fan 140.

The fan motor 130 may be supported by a motor fastening part 125. The rotation shaft of the fan motor 130 may extend upward from the fan motor 130 and may pass through the bottom of the motor fastening part 125 to be connected to the blower fan 140.

Magnets may be disposed on two opposite sides of the fan housing 145. The magnets may be coupled to metallic pieces 15 of the first case 11. In addition, the magnets may be coupled to metallic pieces 15 of the second case 12.

In some embodiments, each of the magnets may include a plurality of magnets. Some of the plurality of magnets may be coupled to the metallic pieces 15 of the first case 11, and the remaining ones of the plurality of magnets may be coupled to the metallic pieces 15 of the second case 12.

The positions of the magnets and the metallic pieces 15 may be set to be opposite those exemplified above. For example, the metallic pieces may be disposed on two opposite sides of the fan housing 145, and the magnets may be disposed at the first case 11 and the second case 12.

The plurality of support parts 150 extends upward from the fan housing 145. For example, the support parts 150 may be beams that are elongated in the longitudinal direction.

A control module 200 is disposed above the filter 120.

A top cover 230 and a case 210 are coupled to each other to form the external appearance of the control module 200, and a main printed circuit board (PCB) on which circuits, such as a controller for control of overall operation of the air cleaner 1, are mounted is accommodated in an inner space defined by the top cover 230 and the case 210.

The case 210 has a central cavity formed therein, and a filter pressing plate 220 is disposed in the central cavity of the case 210. The filter pressing plate 220 may be connected to a plurality of springs (not shown).

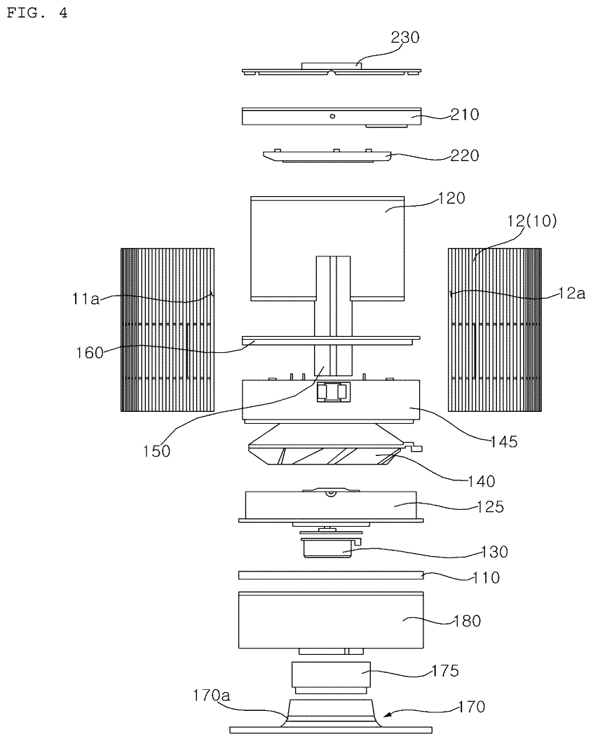

FIGS. 5 to 7 are views for explaining discharge of purified air through the bottom of the air cleaner according to the embodiment of the present disclosure.

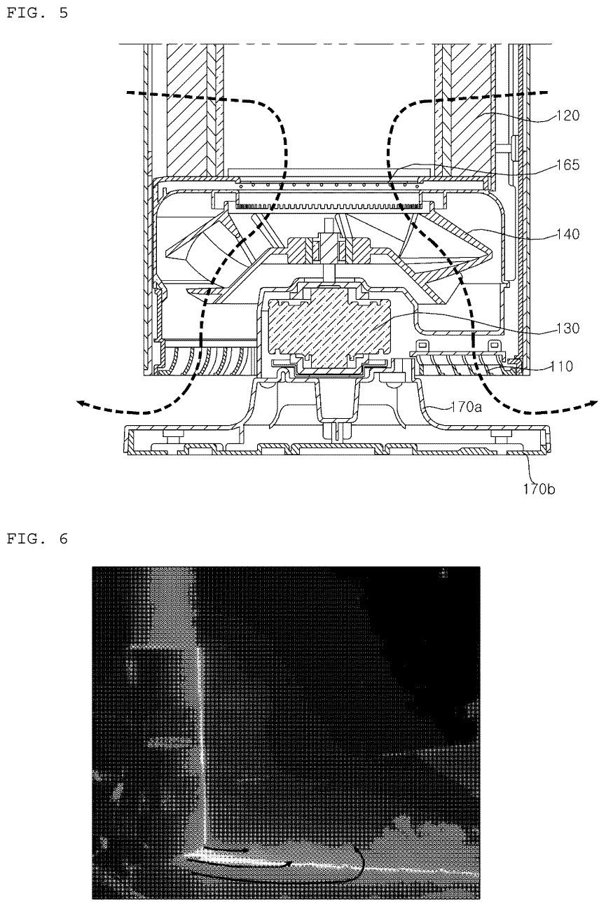

FIG. 5 is a view showing the flow path of the lower discharge airflow, and FIG. 6 is a view visualizing the lower discharge airflow using a laser. FIG. 7 is an enlarged view of a lower discharge airflow guide structure.

Referring to FIGS. 5 to 7, the discharge port 110a is formed in the lower end of the air cleaner 1, and the lower discharge grille 110 is disposed inside the discharge port 110a in order to guide the lower discharge airflow.

The lower discharge grille 110 may include a plurality of grilles. The plurality of grilles may be bent at a predetermined angle in the radially outward direction. The lower discharge grille 110 may be disposed inside the discharge port 110a in order to deliver the lower discharge airflow in the lateral direction.

When the blower fan 140 is rotated by the motor 130, the air purified by the filter 120 is discharged through the discharge port 110a as the lower discharge airflow.

The airflow guide 170a is disposed on the upper surface of the bottom plate 170 in order to guide air discharged downwardly through the discharge port 110a in the lateral direction.

The airflow guide 170a includes a curved portion 173, a flat portion 171 extending laterally from the curved portion 173, and a boss 172 protruding upward from an end portion of the flat portion 171.

The boss 172 may form an airflow that effectively causes allergen particles to float in the air. The boss 172 may reduce flow resistance at the end portion of the flat portion 171. The boss 172 may prevent flow separation at the end portion of the flat portion 171. The boss 172 may be formed in a ring shape along the edge of the airflow guide 170a. The boss 172 may protrude from the flat portion 171 by a predetermined height d1, thereby preventing the occurrence of turbulence at the end portion of the flat portion 171 and causing the airflow to ascend. Accordingly, it is possible to effectively cause allergen particles settled on the floor to float in the air while preventing flow separation.

If the height d1 of the boss 172 is too great, it may excessively increase the degree of ascending of the airflow, which is inappropriate for causing allergen particles settled on the floor to float in the air. For example, it is desirable that the height d1 of the boss 172 be set to several millimeters (mm) or less, so long as the boss 172 is capable of preventing flow separation.

The boss 172 may include an inclined surface, the height of which gradually increases in the radially outward direction. Accordingly, the boss 172 may create an airflow that gradually rises along the inclined surface.

The curved portion 173 may be formed so as to surround the central pillar 175 of the bottom plate 170. The curved portion 173 formed in a curved shape may reduce flow resistance. The curved portion 173, which imparts a curvature to the airflow guide 170a, may be formed so as to be round with a predetermined radius of curvature R1. The radius of curvature R1 may be set so as to guide the lower discharge airflow to smoothly flow in the lateral direction. Further, the maximum height d1 of the boss 172 may be set to be less than 10% of the radius of curvature R1 of the curved portion 173.

The radius of curvature R1 may be set corresponding to the grille bending angle of the lower discharge grille 110. For example, a predetermined angle ag1 based on the vertical direction may be determined corresponding to the grille bending angle of the lower discharge grille 110, and the radius of curvature R1 may be set so as to implement the determined angle ag1. In more detail, the angle ag1 may be set to be smaller than the grille bending angle of the lower discharge grille 110.

The predetermined angle ag1 may be an angle between the central pillar 175 and the curved portion 173. In this case, the predetermined angle ag1 may be smaller than the angle of the discharge airflow through the discharge port 110. The angle of the discharge airflow may correspond to the grille arrangement angle and grille bending angle of the lower discharge grille 110. The grille bending angle may be an angle between an imaginary line extending in the horizontal direction and an imaginary line extending from an end portion of the bent curved section.

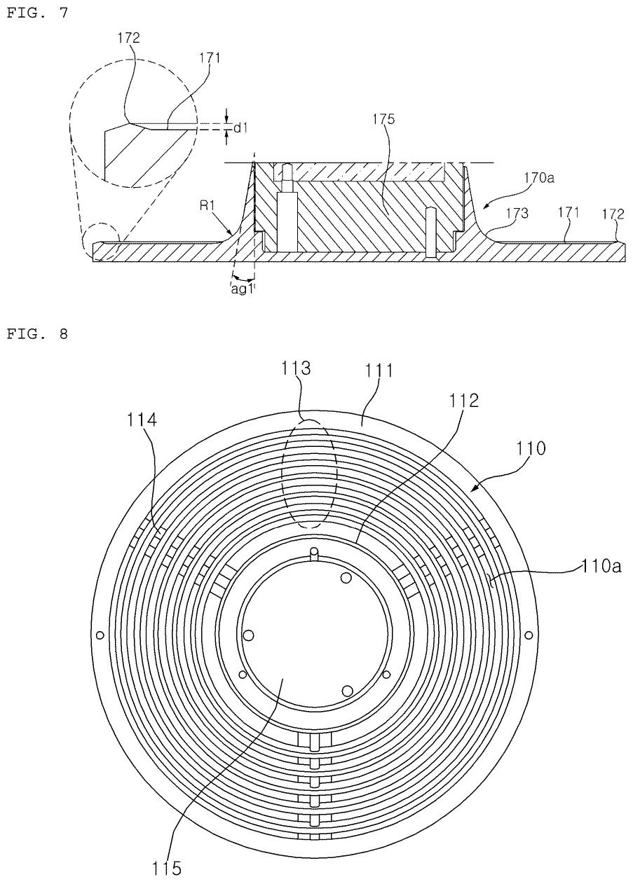

FIGS. 8 and 9 are views for explaining the lower discharge grille according to the embodiment of the present disclosure.

Referring to FIGS. 8 and 9, the lower discharge grille 110 includes an outer wall 111, an inner wall 112, a plurality of grilles 113 disposed between the outer wall 111 and the inner wall 112 and having a concentric circle structure, and a support portion 114 supporting the grilles 113.

A base 115 may be located inside the inner wall 112. The blower fan 140 may be located above the base 115, and the central pillar 175 may be located below the base 115.

The lengths of the grilles 113 may be greater than an interval d2 between the grilles 113. Accordingly, it is possible to secure a sufficient distance for guiding an airflow in the lateral direction.

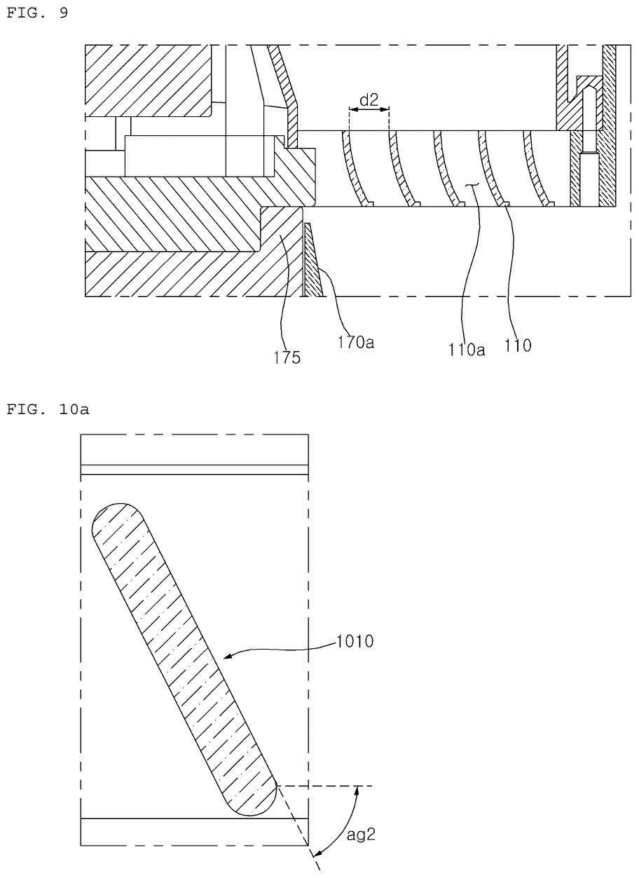

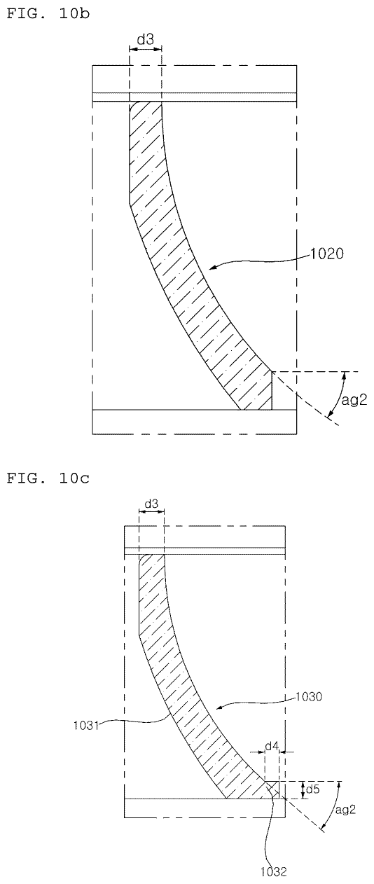

FIGS. 10A to 10C are views for explaining the shape of the grille according to the embodiment of the present disclosure.

Referring to FIG. 10A, a linear grille 1010 may be disposed so as to be inclined at an angle corresponding to a discharge angle ag2. Also in this case, the airflow may be formed along the discharge angle ag2 corresponding to the angle at which the linear grille 1010 is disposed.

Referring to FIG. 10B, a grille 1020 may be bent in the radially outward direction, thereby discharging an airflow at the discharge angle ag2.

The grille bending angle of the lower discharge grille 110 may be set to 20 degrees to 40 degrees so that the airflow rises at 20 degrees or greater in order to cause allergen particles on the floor to float in the air. If the grille bending angle is less than 20 degrees, the airflow may not be sufficiently delivered in the lateral direction. If the grille bending angle is greater than 40 degrees, airflow loss may increase. Thus, allergen particles present around the bottom of the air cleaner 1 may not float in the air.

The thickness d3 of a certain section of the grille 1020 may be set to be different from that of the remaining section of the grille 1020.

Referring to FIG. 10C, a grille 1030 may include a curved portion 1031 bent in the radially outward direction and a protruding portion 1032 protruding from an end portion of the curved portion 1031 in the radially outward direction. That is, the grille 1030 shown in FIG. 10C may be a combination of the grille 1020 shown in FIG. 10B and the protruding portion 1032.

The thickness d5 of the protruding portion 1032 may be smaller than the thickness d3 of the curved portion 1031 so as to guide an airflow in the lateral direction without blocking the same.

Further, the length d4 by which the protruding portion 1032 protrudes in the radially outward direction may be greater than the thickness d3 of the curved portion 1031.

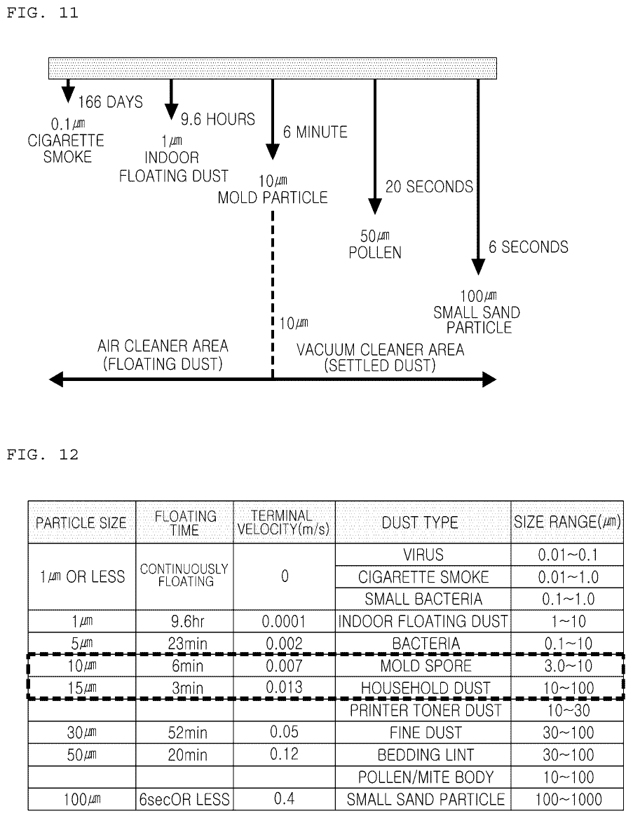

FIGS. 11 and 12 are views for explaining allergen particles.

Referring to FIGS. 11 and 12, general allergen particles, which have a size of about 3 μm to about 100 μm, are larger and heavier than indoor floating dust particles, which have a size of about 1 μm, and thus tend to settle on the floor. For example, mold particles have a size of about 10 μm, household dust allergen particles have a size of about 15 μm, and pollen particles have a size of about 50 μm.

Because virus or cigarette smoke particles have a very small size, the same tend to continuously float without settling on the floor. Indoor floating dust particles remain suspended in the air for a very long time. For example, it takes about 9 to 10 hours for indoor floating dust particles to settle from the ceiling to the floor of the room.

However, under the same conditions, mold particles, household dust allergen particles, and pollen particles float for a short time of several seconds to several minutes and then settle on the floor. Therefore, it is not easy for the conventional air cleaner to capture allergen particles. Conventionally, the only way to remove the settled particles is to use a vacuum cleaner.

According to the present disclosure, the lower airflow discharged downwardly from the air cleaner 1 may cause allergen particles to float in the air, and the floating allergen particles may be captured by the filter 120.

Meanwhile, according to an embodiment of the present disclosure, the speed of the lower discharge airflow may be controlled in response to the terminal velocity of allergen particles. The speed of the lower discharge airflow may be set to be higher than the terminal velocity of allergen particles.

The rotational speed of the blower fan 140 may be controlled based on the terminal velocity of allergen particles. The rotational speed of the blower fan 140 may correspond to the speed of the lower discharge airflow set to be higher than the terminal velocity of allergen particles. The controller of the control module 200 may control the rotational speed of the blower fan 140.

The terminal velocity of allergen particles may be calculated using balance between gravity, buoyancy, and drag force acting on allergen particles. For example, the terminal velocity of allergen particles may be calculated using Stokes' terminal velocity formula.

In order to cause mold particles having a size of about 10 μm and household dust allergen particles having a size of about 15 μm to float in the air, the speed of the lower discharge airflow may be set to be higher than the terminal velocity of larger household dust allergen particles. For example, the speed of the lower discharge airflow may be set to 0.0038 m/s or higher.

The curved portion 173 may guide the lower discharge airflow to smoothly flow in the lateral direction, thereby reducing flow resistance. According to the present disclosure, in order to deliver the lower discharge airflow in the lateral direction, the bottom plate 170 is imparted with a curvature, and the boss 172 is formed at an end portion of the flat portion 171. Accordingly, a turbulent flow for causing allergen particles to float in the air may be created. That is, because the airflow guide 170a is imparted with an inclination and a curvature and is provided with the boss for preventing flow separation, resistance to the lower discharge airflow may be minimized.

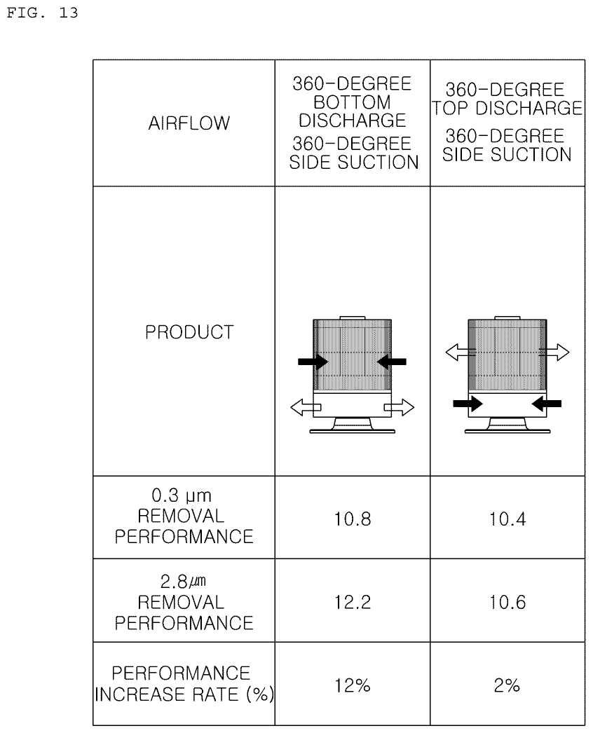

FIG. 13 is a view for explaining performance comparison between an air cleaner that discharges purified air through the bottom thereof and an air cleaner that discharges purified air through the top thereof.

FIG. 13 shows results of evaluating particle removal performance of an air cleaner that suctions air through the side surface thereof and discharges purified air through the bottom thereof and an air cleaner that suctions air through the side surface thereof and discharges purified air through the top thereof when the two types of air cleaners are driven in the same space for the same time period.

Referring to FIG. 13, the two types of air cleaners exhibit similar particle removal performance with respect to a small particle having a size of 0.3 μm.

However, with respect to a large particle having a size of 2.8 μm, the bottom discharge-type air cleaner exhibits particle removal performance of 12.2%, and the top discharge-type air cleaner exhibits particle removal performance of 10.6%. That is, the bottom discharge-type air cleaner exhibits higher particle removal performance than the top discharge-type air cleaner. Further, in the case of the top discharge-type air cleaner, performance of removing a large particle of 2.8 μm is improved only by 2% compared to performance of removing a small particle of 0.3 μm. On the other hand, in the case of the bottom discharge-type air cleaner, performance of removing a large particle of 2.8 μm is improved by 12% compared to performance of removing a small particle of 0.3 μm.

In general, an air cleaner is configured to suction outside air through suction ports formed in the lower portion and/or the central portion thereof and discharge purified air through the top thereof. Such a top discharge structure is effective in removing general fine dust, but is not effective in removing allergen particles and relatively large particles (particle size>1 μm), which commonly tend to settle on the floor, compared to the bottom discharge structure. Further, the top discharge structure has a problem in that the discharge airflow directly reaches a user and thus causes discomfort to the user.

According to the present disclosure, purified air is discharged downwardly through the bottom of the product, thereby preventing the discharge airflow from directly reaching the user and thus causing discomfort to the user. Further, according to the present disclosure, it is possible to create an airflow specialized in removing allergen particles, i.e., a lower discharge airflow that is effective in causing large and heavy particles such as allergen particles to float in the air.

As is apparent from the above description, according to at least one of the embodiments of the present disclosure, because purified air is discharged through a discharge port formed below a blower fan and a filter, it is possible to prevent a discharge airflow from directly reaching a user and thus causing discomfort to the user.

According to at least one of the embodiments of the present disclosure, because purified air is discharged through a discharge port formed in the bottom of the product, it is possible to effectively remove allergens.

According to at least one of the embodiments of the present disclosure, because a lower discharge grille is disposed inside a discharge port in order to guide air discharged downwardly in the radially outward direction, it is possible to more effectively remove large and heavy particles.

According to at least one of the embodiments of the present disclosure, because a plurality of grilles having a concentric circle structure is provided and the length of each of the grilles is set to be greater than an interval between the grilles, it is possible to effectively change the direction of the discharge airflow.

According to at least one of the embodiments of the present disclosure, the plurality of grilles is bent at a predetermined angle in the outward direction, thereby guiding an airflow in the radially outward direction.

According to at least one of the embodiments of the present disclosure, because an upwardly protruding boss is formed on the upper surface of a bottom plate that is disposed below the blower fan and the filter so as to be in contact with the floor, it is possible to create an airflow that is effective in removing allergen particles.

According to at least one of the embodiments of the present disclosure, flow resistance may be reduced due to the boss protruding upward from an end portion of the bottom plate.

According to at least one of the embodiments of the present disclosure, because an airflow guide is disposed on the upper surface of the bottom plate in order to guide air discharged downwardly through the discharge port in the lateral direction, it is possible to effectively change the direction of the discharge airflow.

According to at least one of the embodiments of the present disclosure, because the airflow guide includes a curved portion, flow resistance may be reduced.

The effects achievable through the disclosure are not limited to the above-mentioned effects, and other effects not mentioned herein will be clearly understood by those skilled in the art from the description of the claims.

Other effects will be clearly understood by those skilled in the art from the description of the claims.

Although the present disclosure has been described with reference to specific embodiments shown in the drawings, it is apparent to those skilled in the art that the present disclosure is not limited to those embodiments and is embodied in many forms without departing from the scope of the present disclosure, which is described in the following claims. These modifications should not be individually understood from the technical spirit or scope of the present disclosure.

What is claimed is:

1. An air cleaner comprising:
a case including a suction port disposed in a peripheral surface of the case, the suction port being configured to introduce air to an inside of the case;
a filter configured to remove foreign matter from the air introduced through the suction port;
a blower fan disposed in the case, the blower fan being configured to blow the air introduced through the suction port after the air is filtered by the filter;
a discharge port disposed below the blower fan and the filter, the discharge port being configured to discharge the air blown by the blower fan in a downward direction; and
a bottom plate disposed below the blower fan and the filter, the bottom plate being configured to be in contact with a floor, the bottom plate comprising a boss protruding upward.

2. The air cleaner according to claim 1, wherein the boss comprises a ring shape and is disposed along an edge of the bottom plate.

3. The air cleaner according to claim 1, wherein the boss comprises an inclined surface, and
wherein a height of the inclined surface increases in a radially outward direction.

4. The air cleaner according to claim 1, wherein the bottom plate further comprises a curved portion and a flat portion, the curved portion and the flat portion both being disposed on an upper surface of the bottom plate, and the flat portion extending laterally from the curved portion, and
wherein the boss protrudes upward from an end portion of the flat portion.

5. The air cleaner according to claim 4, wherein a maximum height of the boss is less than 10% of a radius of curvature of the curved portion.

6. The air cleaner according to claim 4, wherein the bottom plate further comprises a central pillar configured to support the blower fan, and
wherein the curved portion is disposed to surround the central pillar.

7. The air cleaner according to claim 6, wherein an angle between the central pillar and the curved portion is smaller than an angle of a discharge airflow through the discharge port and the central pillar.

8. The air cleaner according to claim 1, further comprising a lower discharge grille, the lower discharge grille comprising a plurality of grilles disposed inside the discharge port and being configured to guide air discharged downwardly in a radially outward direction.

9. The air cleaner according to claim 8, wherein the plurality of grilles are arranged in a concentric circle structure.

10. An air cleaner comprising:
a case including a suction port disposed in a peripheral surface of the case, the suction port being configured to introduce air to an inside of the case;
a filter configured to remove foreign matter from the air introduced through the suction port;
a blower fan disposed in the case, the blower fan being configured to blow the air introduced through the suction port after the air is filtered by the filter;
a discharge port disposed below the blower fan and the filter, the discharge port being configured to discharge the air blown by the blower fan in a downward direction; and
a lower discharge grille comprising a plurality of grilles disposed inside the discharge port, the plurality of grilles being arranged in a concentric circle structure and configured to guide the air discharged downwardly in a radially outward direction.

11. The air cleaner according to claim 10, wherein each grille of the plurality of grilles has a length that is greater than a length of an interval between the plurality of grilles.

12. The air cleaner according to claim 10, wherein each of the plurality of grilles is bent at an angle in the radially outward direction.

13. The air cleaner according to claim 12, wherein the angle is in a range of 20 degrees to 40 degrees.

14. The air cleaner according to claim 12, wherein each of the plurality of grilles comprises:
a curved portion bent in the radially outward direction; and
a protruding portion protruding from an end portion of the curved portion in the radially outward direction.

15. The air cleaner according to claim 14, wherein the protruding portion has a smaller thickness than a thickness of the curved portion.

16. The air cleaner according to claim 14, wherein a length of the protruding portion in the radially outward direction is greater than a thickness of the curved portion.

17. The air cleaner according to claim 10, further comprising a bottom plate disposed below the blower fan and the filter that is configured to be in contact with a floor.

18. The air cleaner according to claim 17, wherein the bottom plate comprises an airflow guide disposed on an upper surface of the bottom plate, the airflow guide being configured to guide the air discharged downwardly through the discharge port in a lateral direction.

19. The air cleaner according to claim 18, wherein the airflow guide comprises:
a curved portion;
a flat portion extending laterally from the curved portion; and
a boss protruding upward from an end portion of the flat portion.

20. The air cleaner according to claim 19, wherein the boss includes a ring shape and is disposed along an edge of the airflow guide.
